(19) United States
(12) Patent Application Publication
(10) Pub. No.: US 2022/0196431 A1
(43) Pub. Date: Jun. 23, 2022

(54) DRIVING ASSISTANCE SYSTEM, DRIVING ASSISTANCE APPARATUS, DRIVING ASSISTANCE METHOD, IMAGE RECOGNITION APPARATUS, AND IMAGE RECOGNITION METHOD

(71) Applicant: DENSO CORPORATION, Kariya-city (JP)

(72) Inventors: Ukyo TANIKAWA, Nisshin-city (JP); Shunya KUMANO, Nisshin-city (JP); Yasushi SUEHISA, Kariya-city (JP)

(21) Appl. No.: 17/644,705

(22) Filed: Dec. 16, 2021

(30) Foreign Application Priority Data
Dec. 18, 2020 (JP) 2020-210163

(51) Int. Cl. G01C 21/00; G06V 20/58

(52) U.S. Cl. CPC G01C 21/3807; G06V 20/582; G01C 21/3841; G01C 21/3848

(57) ABSTRACT

A driving assistance system includes a driving assistance apparatus that updates map information based on travel trajectory information that is acquired from a measurement vehicle and provides the map information to a user vehicle that uses the map information. The driving assistance system includes a data storage unit and a map updating unit. The data storage unit stores therein, in time series, pieces of sign data that are related to a road sign and included in the travel trajectory information. The map updating unit updates the map information based on the pieces of sign data that are stored in the data storage unit. The map updating unit references the pieces of sign data that are stored in the data storage unit, identifies a change point in the pieces of sign data that are stored in time series, and updates the map information based on the change point.

### CROSS-REFERENCE TO RELATED APPLICATIONS

This application is based on and claims the benefit of priority from Japanese Patent Application No. 2020-210163, filed on Dec. 18, 2020. The entire disclosure of the above application is incorporated herein by reference.

### BACKGROUND

### Technical Field

The present disclosure relates to a driving assistance system for a vehicle, a driving assistance apparatus, a driving assistance method, an image recognition apparatus, and an image recognition method.

### Related Art

A technology for appropriately recognizing a road sign on a road on which a vehicle is traveling based on a camera image is known. In this technology, a detection position of a road sign and a position of a road sign that is stored in map data are compared. As a result, whether a recognized road sign is a fixed sign or a temporary sign is differentiated.

### SUMMARY

One aspect of the present disclosure provides a driving assistance system that includes a driving assistance apparatus that updates map information based on travel trajectory information that is acquired from a measurement vehicle and provides the map information to a user vehicle that uses the map information. The driving assistance system includes a data storage unit that stores therein, in time series, pieces of sign data that are related to a road sign and included in the travel trajectory information. The driving assistance system updates the map information based on the pieces of sign data that are stored in the data storage unit. The driving assistance system references the pieces of sign data that are stored in the data storage unit, identifies a change point in the pieces of sign data that are stored in time series, and updates the map information based on the change point.

### BRIEF DESCRIPTION OF THE DRAWINGS

In the accompanying drawings:

FIG. 1 is an overall configuration diagram of a driving assistance system;

FIG. 2 is a functional block diagram of a driving assistance apparatus and an image recognition apparatus;

FIG. 3 is a flowchart of an image recognition process according to a first embodiment;

FIG. 4 is a flowchart of a map update process according to the first embodiment;

FIG. 5 is a timing chart of transitions in likelihood;

FIG. 6 is a timing chart of transitions in likelihood;

FIG. 7 is a flowchart of an image recognition process according to a second embodiment;

FIG. 8 is a flowchart of a map generation process according to a third embodiment;

FIG. 9 is a flowchart of an image recognition process according to the third embodiment; and

FIG. 10 is a flowchart of an image recognition process according to a fourth embodiment.

### DESCRIPTION OF THE EMBODIMENTS

A technology for appropriately recognizing a road sign on a road on which a vehicle is traveling based on a camera image is known (JP-A-2012-164254). In JP-A-2012-164254, a detection position of a road sign and a position of a road sign that is stored in map data are compared. As a result, whether a recognized road sign is a fixed sign or a temporary sign is differentiated.

In recent years, advancement has been made in development of technology in which a server acquires travel trajectory information (probe data) from a vehicle over a communication network and generates a map (probe data map; referred to, hereafter, as a PD map) from the pieces of travel trajectory information.

However, in the PD map, differentiation as to whether a road sign is a fixed sign or a temporary sign, as described above, is not made. Therefore, setup and removal of temporary signs are not appropriately updated in the PD map, and may cause erroneous recognition.

It is thus desired to provide a driving assistance system that is capable of appropriately recognizing a road sign, a driving assistance apparatus, a driving assistance method, an image recognition apparatus, and an image recognition method.

A first exemplary embodiment provides a driving assistance system that includes a driving assistance apparatus that updates map information based on travel trajectory information that is acquired from a measurement vehicle and provides the map information to a user vehicle that uses the map information. The driving assistance system includes: a data storage unit that stores therein, in time series, pieces of sign data that are related to a road sign and included in the travel trajectory information; and a map updating unit that updates the map information based on the pieces of sign data that are stored in the data storage unit. The map updating unit references the pieces of sign data that are stored in the data storage unit, identifies a change point in the pieces of sign data that are stored in time series, and updates the map information based on the change point.

A second exemplary embodiment provides a driving assistance apparatus that updates map information based on travel trajectory information that is acquired from a measurement vehicle and provides the map information to a user vehicle that uses the map information. The driving assistance apparatus includes: a data storage unit that stores therein, in time series, pieces of sign data that are related to a road sign and included in the travel trajectory information; and a map updating unit that updates the map information based on the pieces of sign data that are stored in the data storage unit. The map updating unit references the pieces of sign data that are stored in the data storage unit, identifies a change point in the pieces of sign data that are stored in time series, and updates the map information based on the change point.

A third exemplary embodiment provides a driving assistance method that is performed by a driving assistance apparatus that updates map information based on travel trajectory information that is acquired from a measurement vehicle and provides the map information to a user vehicle that uses the map information. The driving assistance method includes: a data storage step of storing, in time series, pieces of sign data that are related to a road sign and included in the travel trajectory information; and a map updating step of updating the map information based on the pieces of sign data that are stored at the data storage step. At the map updating step, the pieces of sign data that are stored at the data storage step are referenced, a change point in the pieces of sign data that are stored in time series is identified, and the map information is updated based on the change point.

In the sign data that is related to a road sign, once the road sign is set, the same sign data should be acquired unless erroneous recognition occurs. Conversely, when a road sign is newly set, or a road sign is removed or changed, the sign data that is related to the road sign that is included in the probe data changes. Therefore, according to the above-described first to third exemplary embodiments, the change point in the pieces of sign data that are stored in time series is identified and the map information is updated based on the change point. As a result, the map information can be appropriately updated at an appropriate timing. In addition, because the change point in the pieces of sign data that are stored in time series is identified, erroneous recognition can be suppressed compared to a case in which the type of the road sign is determined by majority or the like regardless of timing of acquisition.

A fourth exemplary embodiment provides an image recognition apparatus that includes: an image information acquiring unit that acquires image information in which a traveling road on which an own vehicle is traveling is captured; a sign recognizing unit that recognizes a road sign based on the image information; a sign identifying unit that references map information that is generated based on travel trajectory information of a vehicle and identifies a road sign in the vicinity of the own vehicle; a collating unit that collates the road sign that is recognized by the sign recognizing unit and the road sign that is based on the map information, and when the road signs match, sets the matching road sign as a collation result, and when the road signs do not match, selects either of the road signs or selects neither; and an outputting unit that outputs the collation result.

A fifth exemplary embodiment provides an image recognition method that is performed by an image recognition apparatus. The image recognition method includes: an image information acquiring step of acquiring image information in which a traveling road on which an own vehicle is traveling is captured; a sign recognizing step of recognizing a road sign based on the image information; a sign identifying step of referencing map information that is generated based on travel trajectory information of a vehicle and identifying a road sign in the vicinity of the own vehicle; a collating step of collating the road sign that is recognized at the sign recognizing step and the road sign that is based on the map information, and when the road signs match, setting the matching road sign as a collation result, and when the road signs do not match, selecting either of the road signs or selecting neither; and an outputting step of outputting the collation result.

According to the above-described fourth and fifth exemplary embodiments, the road sign that is recognized from the image information and the road sign that is based on the map information are collated. When the road signs match, the matching road sign is set as the collation result. When the road signs do not match, either of the road signs is selected as the collation result, or neither is selected. Therefore, compared to a case in which only a recognition result that is based on the image information is displayed, more accurate information can be provided. In addition, in cases in which a temporary sign is set or removed, more accurate information can be provided.

Embodiments of a driving assistance system will hereinafter be described with reference to the drawings. Here, sections among the embodiments and modifications below that are identical or equivalent are given the same reference numbers in the drawings. Descriptions of sections having the same reference numbers are applicable therebetween.

### First Embodiment

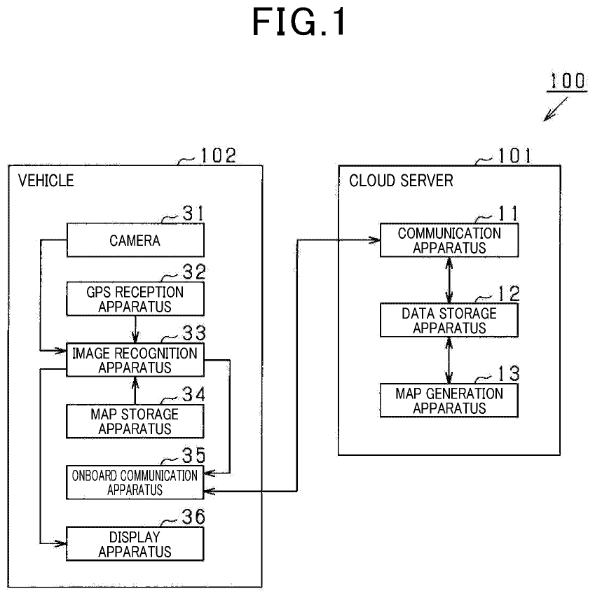

A driving assistance system according to a present embodiment will be described with reference to the drawings. As shown in FIG. 1, a driving assistance system 100 includes a cloud server 101 and a plurality of vehicles 102. The cloud server 101 serves as a driving assistance apparatus. The plurality of vehicles 102 are capable of communicating with the cloud server 101 over a network.

The cloud server 101 updates a PD map that serves as map information based on probe data that is acquired from the vehicle 102 that serves a measurement vehicle. The probe data is travel trajectory information. In addition, the cloud server 101 provides the PD map to the vehicle 102 that serves as a user vehicle that uses the PD map. The cloud server 101 is a computer that includes a central processing unit (CPU), a read-only memory (ROM), a random access memory (RAM), an input/output port, a communication module, and the like.

Specifically, the cloud server 101 includes a communication apparatus 11, a data storage apparatus 12, and a map generation apparatus 13. The communication apparatus 11 transmits and receives the PD map and the probe data. The data storage apparatus 12 stores therein the PD map and the probe data. The map generation apparatus 13 generates and updates the PD map. The communication apparatus 11 is connected to the data storage apparatus 12 and is configured to be capable of receiving and outputting the probe data and the PD map. The data storage apparatus 12 is connected to the map generation apparatus 13 and is configured to be capable of transmitting and receiving various types of data.

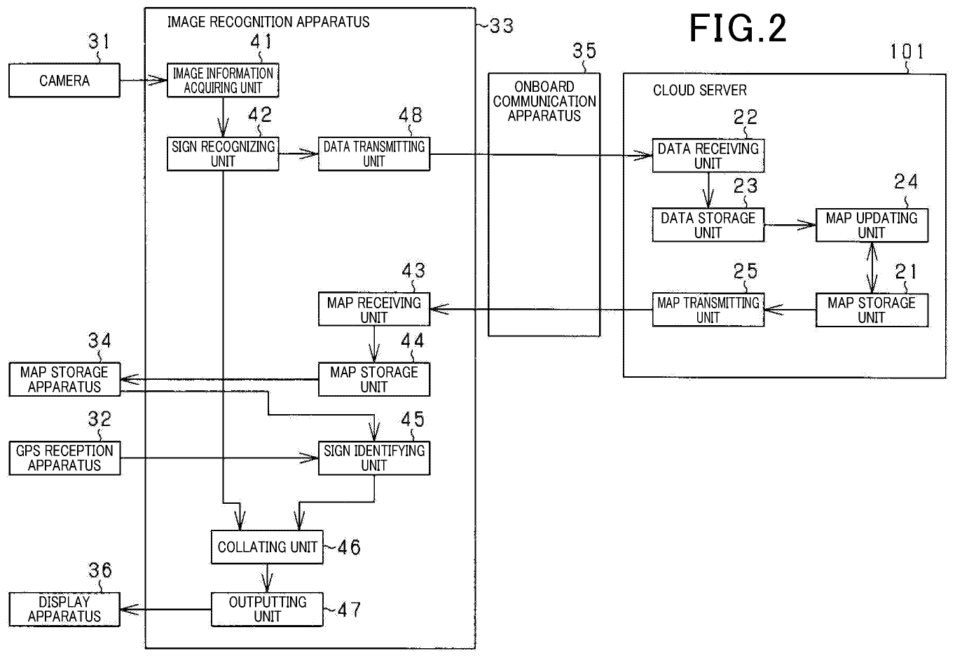

The cloud server 101 implements various functions using the foregoing apparatuses. FIG. 2 shows a functional block diagram of the cloud server 101. As shown in FIG. 2, the cloud server 101 includes a map storage unit 21, a data receiving unit 22, a data storage unit 23, a map updating unit 24, a map transmitting unit 25, and the like. The map storage unit 21 stores therein the PD map. The data receiving unit 22 receives the probe data from the vehicle 102. The data storage unit 23 stores therein the probe data. The map updating unit 24 updates the PD map. The map transmitting unit 25 transmits the PD map. According to the present embodiment, the communication apparatus 11 implements functions of the data receiving unit 22 and the map transmitting unit 25. The data storage apparatus 12 implements functions of the map storage unit 21 and the data storage unit 23. The map generation apparatus 13 implements functions of the map updating unit 24. These various functions will be described hereafter.

Here, the various functions may be implemented by an electronic circuit and the like that are hardware. Alternatively, at least a portion of the various functions may be implemented by software, that is, a process that is performed on a computer. In addition, the cloud server 101 is provided externally to the vehicle 102.

The vehicle 102 includes a single-lens camera 31, a global positioning system (GPS) reception apparatus 32, an image recognition apparatus 33, a map storage apparatus 34, an onboard communication apparatus 35, a display apparatus 36, and the like. The camera 31 serves as an imaging apparatus (image sensor).

The camera 31 is a camera in which an image sensor such as a charge-coupled device (CCD) or a complementary-metal-oxide semiconductor (CMOS) is used. For example, the camera 31 may be arranged near an upper end of a front windshield of a vehicle and captures (images) a surrounding environment that includes a road (traveling road) ahead of the own vehicle. A captured image that is captured by the camera 31 is outputted to the image recognition apparatus 33. Here, a plurality of cameras (multiple-lens camera) may be provided.

The GPS reception apparatus 32 provides a function for receiving position information (a current position of the vehicle 102) through a positioning function of the GPS and outputting the position information to the image recognition apparatus 33. The map storage apparatus 34 stores therein the PD map that is provided from the cloud server 101 and outputs the PD map to the image recognition apparatus 33. The onboard communication apparatus 35 communicates with the cloud server 101, and performs transmission of the probe data and reception of the PD map. The display apparatus 36 is connected to the image recognition apparatus 33 and displays recognition results that are outputted from the image recognition apparatus 33.

The image recognition apparatus 33 is a computer that includes a CPU, a ROM, a RAM, an input/output port, and the like. The image recognition apparatus 33 provides various functions and, for example, may perform image recognition. The various functions are implemented by a program that is stored in the ROM that is provided in the image recognition apparatus 33 or the like being run.

FIG. 2 shows a functional block diagram of the image recognition apparatus 33. As shown in FIG. 2, the image recognition apparatus 33 provides functions of an image information acquiring unit 41, a sign recognizing unit 42, a map receiving unit 43, a map storage unit 44, a sign identifying unit 45, a collating unit (comparison unit) 46, an outputting unit 47, and a data transmitting unit 48. These various functions will be described hereafter. Here, the various functions may be implemented by an electronic circuit that is hardware. Alternatively, at least a portion of the various functions may be implemented by software, that is, a process that is performed on a computer.

Next, the various functions provided by the cloud server 101 and the image recognition apparatus 33 will be described with reference to FIG. 2. First, the functions on the image recognition apparatus 33 side will be described.

The image information acquiring unit 41 acquires a captured image (image information) that is captured by the camera 31 at a predetermined cycle. The sign recognizing unit 42 identifies a road sign from the captured image that is acquired by the image information acquiring unit 41.

Specifically, the sign recognizing unit 42 determines a type of a road sign that is present ahead of the own vehicle based on the acquired captured image and dictionary information for road sign identification that is prepared in advance. For example, the dictionary information for road sign identification may be individually prepared based on the type of the road sign, such as a guidance sign, a warning sign, a regulatory sign, an instruction sign, or an auxiliary sign. The dictionary information for road sign identification is stored in advance in a memory such as the ROM.

The sign recognizing unit 42 determines the type of the road sign by collating the captured image and the dictionary information by pattern matching. A recognition method for the road sign is not limited thereto and may be arbitrarily changed. In addition, when the type of the road sign is recognized, machine learning such as a deep neural network (DNN) may be used.

Furthermore, the sign recognizing unit 42 identifies a position information of the road sign. Specifically, the sign recognizing unit 42 identifies the position information (longitude and latitude) of a position in which the road sign is detected, based on a relative position of the road sign with reference to the own vehicle and position information (longitude and latitude) of the own vehicle that is received from the GPS reception apparatus 32.

The sign recognizing unit 42 then outputs information that is related to the type and the position information (longitude and latitude) of the road sign as sign data. At this time, the sign recognizing unit 42 may include a recognition confidence level related to recognition of the road sign based on the captured image in the sign data. The recognition confidence level indicates, by probability or the like, a likelihood of a road sign that is actually set being the type that is indicated in the sign data. For example, when collation by pattern matching is performed, the recognition confidence level may be calculated based on a degree of matching.

The map receiving unit 43 receives the PD map that is provided from the cloud server 101 through the onboard communication apparatus 35. The PD map is transmitted from the cloud server 101 at a predetermined timing. In addition, the map receiving unit 43 may request transmission of the PD map from the cloud server 101 at a predetermined timing. The map storage unit 44 stores the PD map that is received by the map receiving unit 43 in the map storage apparatus 34.

The sign identifying unit 45 references the PD map that is received by the map receiving unit 43, that is, the PD map that is stored in the map storage apparatus 34 and identifies a road sign (the position information, type, and the like of a road sign) that is in the vicinity of the own vehicle based on the position information (longitude and latitude) of the own vehicle that is received from the GPS reception apparatus 32.

The collating unit 46 collates (compares) the road sign that is recognized by the sign recognizing unit 42 and the road sign that is identified by the sign identifying unit 54 based on the PD map, and selects either of the road signs as a collation result. Specifically, the collating unit 46 compares the pieces of position information and identifies a road sign, among the road signs in the vicinity of the own vehicle that are identified by the sign identifying unit 45, of which the position information is closest to the position information of the road sign that is recognized by the sign recognizing unit 42. Then, the collating unit 46 compares the type of the identified road sign and the type of the road sign that is recognized by the sign recognizing unit 42, and determines whether the types match. When the types match, the collating unit 46 sets the matching type of road sign as the collation result. Meanwhile, when the types do not match, the collating unit 46 sets the type of the road sign that is recognized by the sign recognizing unit 42 as the collation result.

The outputting unit 47 outputs the collation result from the collating unit 46 to the display apparatus 36 and makes the display apparatus 36 display the road sign that serves as the collation result. The data transmitting unit 48 transmits the probe data to the cloud server 101 through the onboard communication apparatus 35. According to the present embodiment, the probe data includes at least the recognition result from the sign recognizing unit 42, that is, the sign data related to the road sign.

Here, the probe data may also include a travel history of the own vehicle (such as a vehicle speed, front/rear acceleration, and left/right acceleration), the position information of the vehicle 102, a road shape, position information of a traffic light, time information (such as time of detection), transit time from an intersection to an intersection, and the like.

Next, the functions on the cloud server 101 side will be described. The map storage unit 21 stores therein a newest PD map. The data receiving unit 22 receives the probe data from the vehicle 102 and outputs the probe data to the data storage unit 23. The data storage unit 23 stores therein the probe data that is inputted from the data receiving unit 22. At this time, the data storage unit 23 stores at least the pieces of sign data related to the road signs that are included in the pieces of probe data in time series.

The map updating unit 24 updates the PD map based on the sign data that is stored in the data storage unit 23 and stores the newest PD map in the map storage unit 21. At this time, the map updating unit 24 references the pieces of sign data that are stored in the data storage unit 23, identifies a change point in the pieces of sign data that are stored in time series, and updates the PD map based on the change point.

More specifically, in pieces of sign data of which the pieces of position information correspond to one another, the map updating unit 24 calculates changes over time in likelihood that is based on the number of pieces of stored sign data, for each type. The map updating unit 24 identifies the change point in the pieces of sign data based on at least one of increase and decrease in likelihood.

The pieces of sign data of which the pieces of position information correspond to one another are pieces of sign data of which a difference in the position information that is included in the sign data is within a predetermined range. For example, the pieces of sign data of which the pieces of position information correspond to one another may be pieces of sign data of which a difference in latitude is within a predetermined range and a difference in longitude is within a predetermined range.

The likelihood refers to a likelihood (certainty level) of a type of road sign, among the types of road sign indicated by the pieces of sign data of which the pieces of position information correspond to one another, being an actual type of the road sign. The likelihood is calculated for each type. The map updating unit 24 calculates a higher likelihood as the number of pieces of stored sign data that indicates the target type increases during a predetermined unit period.

Here, even when the number of pieces of stored sign data is the same, the likelihood differs due to differences in the number of pieces of probe data that serve as a basis for generation, that is, the number of samples. That is, even when the number of pieces of stored sign data is the same, when the number of pieces of probe data is large, the likelihood is lower compared to that when the number of pieces of probe data is small.

Therefore, the map updating unit 24 calculates the likelihood upon performing normalization based on the number of pieces of probe data that serve as the basis for generation. Specifically, the map updating unit 24 calculates the likelihood based on a proportion of the number of pieces of stored sign data in relation to the number of pieces of probe data that serve as the basis for generation during a predetermined unit period. The number of pieces of probe data that serve as the basis for generation may be a total number of pieces of probe data that are received (or stored) per unit period. Alternatively, the number of pieces of probe data that serve as the basis for generation may be a total number of pieces of probe data that are received per unit period from the vehicles 102 that are present within a predetermined area that is centered on the position that is indicated by the position information of the target road sign.

In addition, when each piece of sign data includes the recognition confidence level related to recognition of the road sign, the map updating unit 24 may calculate the likelihood for each type upon weighting the pieces of sign data based on the respective recognition confidence levels. For example, the map updating unit 24 may perform weighting by integrating the recognition confidence levels of the pieces of sign data of the target type during a predetermined unit period. That is, the map updating unit 24 may perform weighting by integrating values that are each obtained by the number of pieces of stored sign data “1” being multiplied by the recognition confidence level.

Furthermore, in the road signs that are indicated by the pieces of sign data of which the pieces of position information correspond to one another, as described above, the map updating unit 24 calculates changes over time in the likelihood for each type of road sign. Then, the map updating unit 24 identifies the change point of the likelihood based on the changes over time in the likelihood for each type of road sign. Specifically, when the likelihood increases by a first determination value or more, or when the likelihood decreases by a second determination value or more during a predetermined period, the map updating unit 24 identifies this at least one of increase and decrease as the change point of the likelihood.

That is, when a road sign is set, the number of pieces of stored sign data that indicate the type of the road sign tends to increase. Therefore, when the likelihood increases by the first determination value or more during the predetermined period, the map updating unit 24 determines that the road sign has been set during the predetermined period and updates the PD map.

Meanwhile, when a road sign is removed, the number of pieces of stored sign data that indicate the type of the road sign tends to decrease. Therefore, when the likelihood decreases by the second determination value or more during the predetermined period, the map updating unit 24 determines that the road sign has been removed during the predetermined period and updates the PD map.

Here, a case in which a road sign is changed is equivalent to setup and removal of road signs being simultaneously performed. That is, when the road sign is changed, the number of pieces of stored sign data that indicate the type of the road sign before change tends to decrease and the number of pieces of stored sign data that indicate the type of the road sign after change tends to increase.

Therefore, when the likelihood that indicates the type of the road sign before change decreases by the second determination value or more and the likelihood that indicates the type of the road sign after change increases by the first determination value or more during a predetermined period, the map updating unit 24 determines that the road sign has been changed during the predetermined period and updates the PD map.

When the PD map is updated, the map updating unit 24 stores the PD map after the update to the map storage unit 21 as the newest PD map. The map transmitting unit 25 reads the newest PD map from the map storage unit 21 at a predetermined timing and transmits the newest PD map to the vehicle 102. For example, the map transmitting unit 25 may transmit the PD map to the vehicle 102 at a predetermined time or on a predetermined day. Alternatively, the map transmitting unit 25 may transmit the PD map to the vehicle 102 based on a request from the vehicle 102.

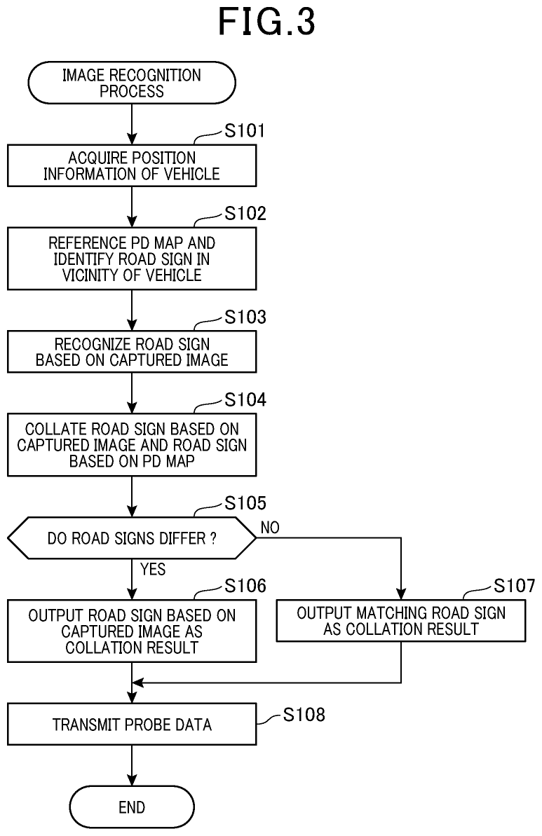

Next, a flow of an image recognition process (image recognition method) that is performed on the vehicle 102 side when a road sign is recognized will be described with reference to FIG. 3. The image recognition process is performed by the image recognition apparatus 33 at every predetermined cycle.

First, the image recognition apparatus 33 acquires the position information of the vehicle 102 (own vehicle) from the GPS reception apparatus 32 (step S101). Next, the image recognition apparatus 33 references the PD map that is stored in the image storage apparatus 34 and identifies a road sign in the vicinity of the own vehicle based on the position information (longitude and latitude) of the own vehicle received from the GPS reception apparatus 32 (step S102). As a result of this step S102, the image recognition apparatus 33 functions as the sign identifying unit 45. In addition, step S102 is a sign identifying step.

Then, the image recognition apparatus 33 acquires a captured image from the camera 31 and recognizes a road sign based on the captured image (step S103). At this time, as described above, the image recognition apparatus 33 recognizes the type and the position information of the road sign. In addition, the image recognition apparatus 33 also calculates the recognition confidence level. As a result of the process at step S103, the sign recognition apparatus 33 functions as the image information acquiring unit 41. In addition, the image recognition apparatus 33 functions as the sign recognizing unit 42. Furthermore, step S103 is an image information acquiring step and a sign recognizing step.

Next, the image recognition apparatus 33 collates the road sign that is recognized at step S103 and the road sign that is based on the PD map, as described above (step S104). Then, the image recognition apparatus 33 determines whether the road sign that is recognized at step S103 and the road sign that is based on the PD map differ (step S105).

When the determination result is affirmative, that is, when the road signs differ, the image recognition apparatus 33 outputs, to the display apparatus 36, the collation result that is the type of the road sign that is recognized at step S103 (step S106). That is, the image recognition apparatus 33 makes the display apparatus 36 displays the road sign that is based on the captured image as the collation result.

Here, when a road sign of which the position information corresponds to the position information of the road sign that is based on the captured image is not present in the PD map at step S105, the image recognition apparatus 33 determines that the road signs differ (makes an affirmative determination). In a similar manner, when a road sign of which the position information corresponds to the position information of the road sign that is based on the PD map is not present in the captured image, the image recognition apparatus 33 determines that the road signs differ (makes an affirmative determination).

Meanwhile, when the determination result at step S105 is negative, that is, when the road signs match, the image recognition apparatus 33 outputs, to the display apparatus 36, the collation result that is the road sign of the matching type (step S107). As a result of steps S104 to S107, the image recognition apparatus 33 functions as the collating unit 46. In addition, steps S104 to S107 are a collating step. Furthermore, as a result of step S107, the image recognition apparatus 33 functions as the outputting unit 47. Step S107 is an outputting step.

When the process at step S106 or S107 is ended, the image recognition apparatus 33 generates the probe data that includes the sign data of the road sign that is recognized based on the captured image, and transmits the probe data to the cloud server 101 through the onboard communication apparatus 35 (step S108). As a result of step S108, the image recognition apparatus 33 functions as the data transmitting unit 48. In addition, step S108 is a data transmitting step.

Next, processes (driving assistance method) on the cloud server 101 side will be described. First, a storage process that is performed when the probe data is received will be described. When the probe data is received, the cloud server 101 stores the probe data in time series. More specifically, when the probe data is received, the communication apparatus 11 outputs the probe data to the data storage apparatus 12. The data storage apparatus 12 stores the inputted probe data in time series. At this time, the sign data that is included in the probe data is also stored in time series. This storage process corresponds to a data storage step.

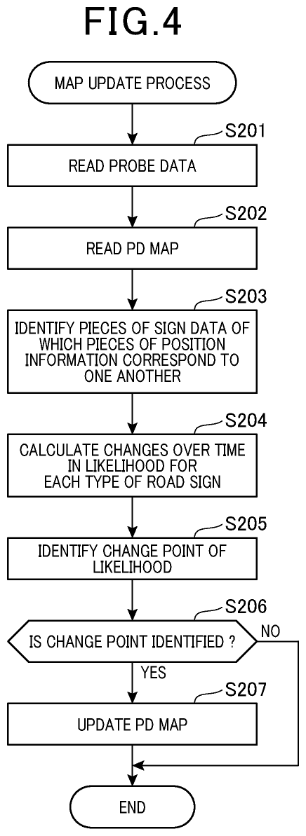

Next, a flow of a map update process that is performed when the PD map is updated will be described with reference to FIG. 4. The map update process is performed at a predetermined timing by the cloud server 101. The map update process corresponds to a map updating step.

The cloud server 101 reads the probe data that is stored (step S201). That is, the map generation apparatus 13 reads a plurality of pieces of probe data that are stored in time series from the data storage apparatus 12. Then, the cloud server 101 reads the newest PD map that is stored (step S202). That is, the map generation apparatus 13 reads the newest PD map from the data storage apparatus 12.

Next, the cloud server 101 identifies the pieces of sign data of which the pieces of position information correspond to one another, among the pieces of sign data that are included in the pieces of probe data that are read, as described above (step S203). That is, the map generation apparatus 13 identifies the pieces of sign data of which the pieces of position information correspond to one another.

Then, in the pieces of sign data of which the pieces of position information correspond to one another that are identified at step S203, the cloud server 101 calculates the changes over time in likelihood that is based on the number of pieces of stored sign data, for each type (step S204). Thus, in the pieces of sign data of which the pieces of position information correspond to one another that are identified at step S203, the map generation apparatus 13 integrates the number of pieces of sign data (that is, the number of pieces of stored sign data) for each type.

At this time, the map generation apparatus 13 determines transitions in likelihood for each type by integrating the number of pieces of stored sign data per predetermined unit period and lining the numbers in time series. Here, when the sign data includes the recognition confidence level, the map generation apparatus 13 integrates the number of pieces of stored sign data upon weighting based on the recognition confidence levels, and calculates the likelihood for each type.

In addition, at this time, the map generation apparatus 13 calculates the likelihood for each type by normalizing the number of pieces of stored sign data by the number of pieces of probe data for every unit period. That is, the map generation apparatus 13 calculates the likelihood for each type based on a proportion of the number of pieces of stored sign data in relation to the number of pieces of probe data for every unit period.

Here, according to the present embodiment, normalization is performed based on the number of pieces of probe data. However, normalization may not be performed. In addition, weighting based on the recognition confidence levels may not be performed. That is, the map generation apparatus 13 may merely calculate the transitions in the number of pieces of stored sign data per predetermined unit period.

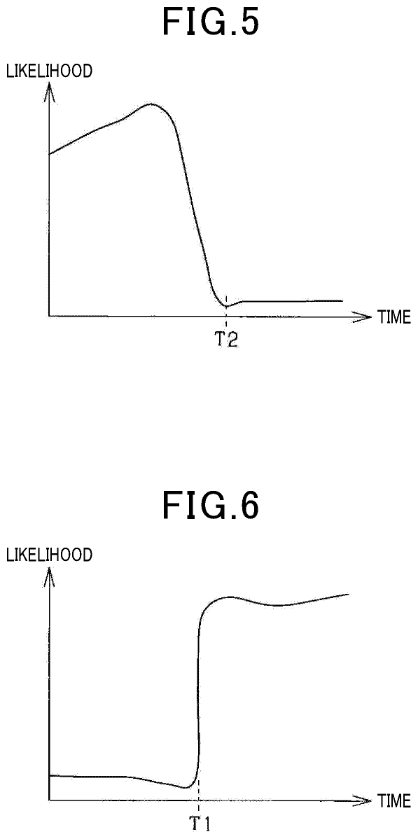

Next, the cloud server 101 identifies the change point from the changes over time in likelihood for each type that are calculated at step S204 (step S205). For example, when the likelihood for each type decreases by the second determination value or more during a predetermined test period (such as two to a hundred unit periods), the map generation apparatus 13 may identify the change point to have occurred at time T2 at which the likelihood decreases by the second determination value or more (see FIG. 5).

Meanwhile, when the likelihood for each type increases by the first determination value or more during a predetermined test period (such as two to a hundred unit periods), the map generation apparatus 13 identifies the change point to have occurred at time T1 at which the likelihood increases by the first determination value or more (see FIG. 6).

Here, when the likelihoods of a plurality of types are identified at step S205, the change point may be identified from the changes over time in the likelihood of a single type or the likelihoods of two types, among the types of which the pieces of stored sign data are many. In addition, when the likelihoods of a plurality of types are identified, the likelihood of a type of which the likelihood or the number of pieces of stored sign data is equal to or less than a predetermined number may be ignored.

Then, the cloud server 101 determines whether the change point is identified (whether the change point is generated) at step S205 (step S206). When the determination result at step S206 is negative, the map update process is immediately ended.

Meanwhile, when the determination result at step S206 is affirmative, the cloud server 101 updates the PD map (step S207). Specifically, when the change point at which the likelihood of a certain type increases by the first determination value or more is identified, the map generation apparatus 13 determines that a road sign of this certain type has been set. The map generation apparatus 13 updates the PD map and stores the PD map in the data storage apparatus 12. At this time, the map generation apparatus 13 averages the pieces of position information of the road sign of the certain type, among the pieces of sign data that indicate the certain type, and sets the average position information as the position information of the road sign in the PD map.

Meanwhile, when the change point at which the likelihood of a certain type decreases by the second determination value or more is identified, the map generation apparatus 13 determines that the road sign of this certain type has been removed. The map generation apparatus 13 updates the PD map and stores the PD map in the data storage apparatus 12. The map update process is then ended.

According to the above-described embodiment, excellent effects such as those below can be achieved.

In the sign data that is related to a road sign, once the road sign is set, the same sign data should be acquired unless erroneous recognition occurs. Conversely, when a road sign is newly set, or a road sign is removed or changed, the sign data that is related to the road sign that is included in the probe data changes. Therefore, the cloud server 101 can appropriately update the PD map at an appropriate timing by identifying the change point in the pieces of sign data that are stored in time series and updating the PD map based on the change point. In addition, because the change point in the pieces of sign data that are stored in time series is identified, erroneous recognition can be suppressed compared to a case in which the type of the road sign is determined by majority voting or the like regardless of timing of acquisition.

When a road sign is newly set, or a road sign is removed or changed, a significant change often occurs in the number of pieces of stored sign data for each type. Therefore, in the pieces of sign data of which the pieces of position information correspond to one another, the cloud server 101 integrates the number of pieces of stored sign data for each type for every unit period, and calculates the changes over time in likelihood based on the number of pieces of stored sign data. Therefore, the cloud server 101 can appropriately identify the change point in the pieces of sign data by monitoring the at least one of increase and decrease in likelihood based on the changes over time.

In addition, the could server 101 calculates the changes over time in likelihood for each type upon weighting based on the recognition confidence levels, taking into consideration the possibility of erroneous recognition when the vehicle recognizing the road sign. As a result, the change point in the pieces of sign data can be appropriately identified upon taking into consideration the possibility of erroneous recognition.

Furthermore, even when the number of pieces of stored sign data per unit period is the same, the likelihood differs due to differences in the number of pieces of probe data that serve as the basis for generation, that is, the number of samples. Therefore, the cloud server 101 calculates the likelihood upon normalizing based on the number of pieces of probe data that serve as the basis for generation. As a result, the change point can be more accurately identified.

The image recognition apparatus 33 in the vehicle 102 that uses the PD map includes the collating unit 46 that collates the road sign that is recognized based on a captured image and the road sign that is based on the PD map, and selects either road sign as the collation result. As a result, because the vehicle 102 that uses the PD map also recognizes the road sign and collates the road signs, more accurate information related to the road sign can be outputted.

When the road sign that is recognized based on the captured image and the road sign that is based on the map information do not match, the collating unit 46 sets the road sign that is recognized based on the captured image as the collation result. That is, compared to the road sign that is based on the PD map, the road sign that is recognized based on the captured image is based on newer information and is more likely to be accurate. Therefore, when the road signs do not match, the road sign that is recognized by the sign recognizing unit is preferentially outputted.

The vehicle 102 that uses the PD map is also the measurement vehicle. The vehicle 102 includes the sign data of the road sign that is recognized by the image recognition apparatus 33 in the probe data and transmits the probe data to the cloud server 101. As a result, the vehicle 102 can perform accurate output of the road sign and the cloud server 101 can collect a greater number of pieces of probe data based on usage of the vehicles 102.

The image recognition apparatus 33 recognizes the road sign by using machine learning. As a result, the road sign can be more accurately recognized.

### Second Embodiment

A portion of the driving assistance system according to the above-described first embodiment may be modified in a following manner. Here, according to a second embodiment below, descriptions of sections that are identical or equivalent to those according to the first embodiment are omitted. Descriptions according to the first embodiment are applicable to these sections.

According to the second embodiment, the image recognition apparatus 33 of the vehicle 102 is configured to be capable of performing scene determination in which a construction zone is determined from a captured image. That is, the image recognition apparatus 33 includes a scene determining unit that identifies a construction zone from the captured image. The image recognition apparatus 33 that serves as the scene determining unit identifies a construction zone based on whether an object that indicates that construction is being performed is present in the captured image.

Specifically, the image recognition apparatus 33 determines that the construction zone is present when a sign or a signboard that indicates that construction is being performed can be recognized or when a fixed number or more of objects (such as pylons, barricades, and construction vehicles) that are unique to construction zones can be recognized in the captured image. Here, a recognition method for objects that indicate that construction is being performed may be performed in a manner that is similar to the recognition method for road signs (pattern matching or the like).

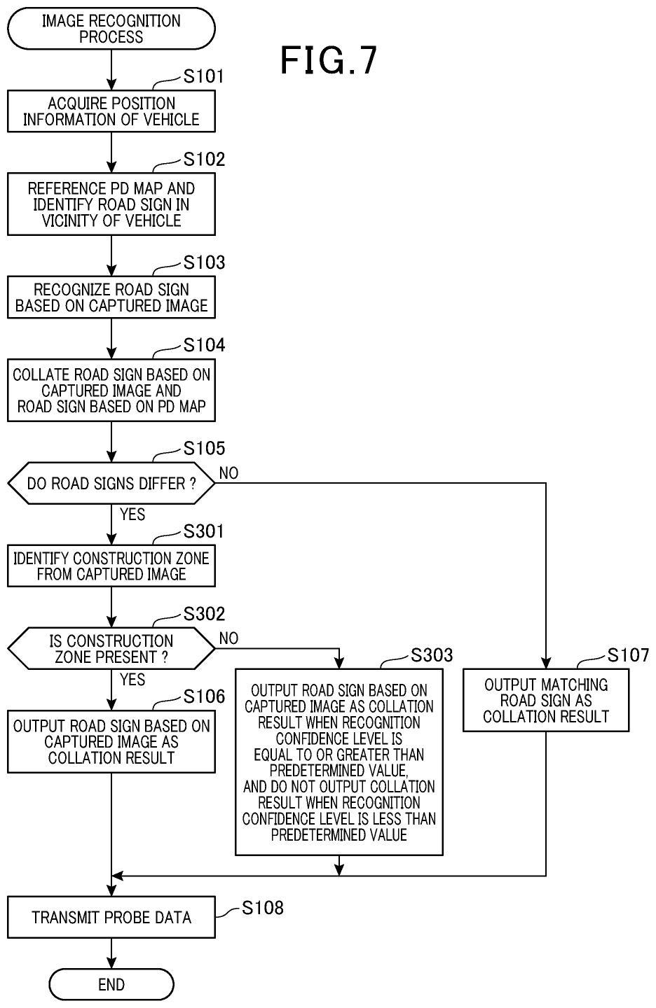

Next, a flow of an image recognition process according to the second embodiment will be described with reference to FIG. 7. First, in a manner similar to that according to the first embodiment, the image recognition apparatus 33 performs the processes at steps S101 to S105.

When the determination result at step S105 is affirmative, that is, when the road sign that is based on the captured image and the road sign that is based on the PD map differ, the image recognition apparatus 33 performs the scene determination to identify a construction zone from the captured image (step S301). Then, the image recognition apparatus 33 determines whether a construction zone has been identified from the captured image (step S302). As a result of steps S301 and S302, the image recognition apparatus 33 functions as a scene determining unit. In addition, steps S301 and S302 are a scene determining step.

When the determination result at step S302 is affirmative, that is, when the construction zone is recognized, the image recognition apparatus 33 outputs, to the display apparatus 36, the collation result that is the type of the road sign that is recognized at step S103 (step S106). That is, the image recognition apparatus 33 makes the display apparatus 36 display the road sign that is based on the captured image as the collation result.

Meanwhile, when the determination result at step S302 is negative, that is, when the construction zone is not recognized, when the recognition confidence level of the road sign that is based on the captured image is equal to or greater than a predetermined value, the image recognition apparatus 33 outputs, to the display apparatus 36, the collation result that is the type of the road sign that is recognized at step S103. When the recognition confidence level of the road sign that is based on the captured image is less than the predetermined value, the image recognition apparatus 33 determines that the determination cannot be made (step S303). Here, when the determination cannot be made, the image recognition apparatus 33 does not make the display apparatus 36 display a collation result.

Meanwhile, when the determination result at step S105 is negative, that is, when the road signs match, the image recognition apparatus 33 outputs, to the display apparatus 36, the collation result that is the road sign of the matching type (step S107).

When the process at step S106, S107, or S303 is ended, the image recognition apparatus 33 generates the probe data that includes the sign data of the road sign that is recognized based on the captured image, and transmits the probe data to the cloud server 101 through the onboard communication apparatus 35 (step S108).

According to the second embodiment, when the road sign that is to be collated is provided in a construction zone in which temporary road signs are frequently set and the road signs do not match, the image recognition apparatus 33 preferentially outputs the road sign that is recognized from the captured image. As a result, the road sign can be more accurately displayed.

### Third Embodiment

A portion of the driving assistance system according to the above-described first embodiment may be modified in a following manner. Here, according to a third embodiment below, descriptions of sections that are identical or equivalent to those according to the first embodiment are omitted.

First, a storage process according to the third embodiment will be described. When the probe data is received, the cloud server 101 stores the probe data. More specifically, when the probe data is received, the communication apparatus 11 outputs the probe data to the data storage apparatus 12. The data storage apparatus 12 stores the inputted probe data. This storage process corresponds to a data storage step.

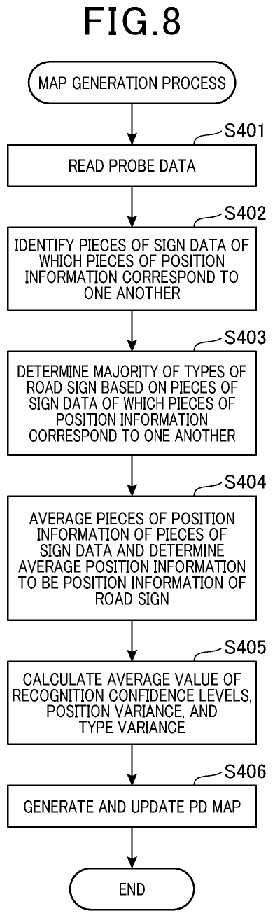

Next, a flow of a map generation process according to the third embodiment will be described with reference to FIG. 8. The map generation process is performed at a predetermined timing by the cloud server 101. The cloud server 101 reads the probe data that is stored (step S401). That is, the map generation apparatus 13 reads the plurality of pieces of stored probe data from the data storage apparatus 12. Next, the cloud server 101 identifies the pieces of sign data of which the pieces of position information correspond to one another, among the pieces of sign data that are included in the pieces of read probe data, as described above (step S402). That is, the map generation apparatus 13 identifies the pieces of sign data of which the pieces of position information correspond to one another.

Then, the cloud server 101 determines the majority of the types of road sign related to the pieces of sign data of which the pieces of position information correspond to one another that are identified at step S402, and determines the road sign of the type of which the number of pieces of stored sign data is greatest as the road sign that is published in the PD map (step S403). Here, when the greatest number of pieces of stored sign data is equal to or less than a predetermined number at step S403, the recognition result may be ignored as erroneous recognition. The predetermined number may be set as appropriate based on the total number of pieces of probe data.

In addition, the cloud server 101 averages the pieces of position information of the pieces of sign data that are identified at step S402 and determines the average position information as the position information of the road sign that is determined at step S403 (the position information that is published in the PD map) (step S404).

Furthermore, the cloud server 101 calculates the number of pieces of data, an average value of the recognition confidence levels, a position variance, and a type variance from the pieces of sign data that are identified at step S402 (step S405).

The number of pieces of data is a total number of the pieces of (probe data that include) sign data that are identified at step S402. The average value of the recognition confidence levels is calculated by the recognition confidence levels that are included in the pieces of sign data identified at step S402 being averaged. The position variance indicates a magnitude of scatter in the pieces of position information that indicate positions in which the road signs that are included in the pieces of sign data in the pieces of probe data that serve as the basis for generation of the road sign that is determined at step S403 are detected. The position variance is calculated based on the scatter (variation) in the pieces of position information in the pieces of sign data that are identified at step S402. The position variance increases as the scatter increases. The position variance decreases as the scatter decreases.

The type variance indicates a magnitude of scatter in the types of the road signs that are included in the pieces of sign data that serve as the basis for generation of the road sign that is determined at step S403. The type variance is calculated based on the scatter (variation) in the types in the pieces of sign data that are identified at step S402. The type variance increases as the scatter increases. The type variance decreases as the scatter decreases.

In addition, the cloud server 101 generates the PD map based on the information that is determined or calculated at steps S403 to S405 and updates the PD map (step S406). That is, the map generation apparatus 13 generates the PD map such that the road sign of the type that is determined at step S403 is present in the position that is indicated by the position information that is determined at step S404, and stores the PD map in the data storage apparatus 12. When the PD map is generated and updated, the map generation apparatus 13 stores the number of pieces of data, the average value of the recognition confidence levels, the position variance, and the type variance that are calculated at step S405 together in association with the type and the position information of each road sign. Then, the map generation process is ended.

The updated PD map is transmitted from the cloud server 101 to the vehicle 102 at a predetermined timing in a manner similar to that according to the above-described embodiments. When the PD map is transmitted, the various pieces of information (the number of pieces of data, the average value of the recognition confidence levels, the position variance, and the type variance) that are associated with the road sign are also transmitted.

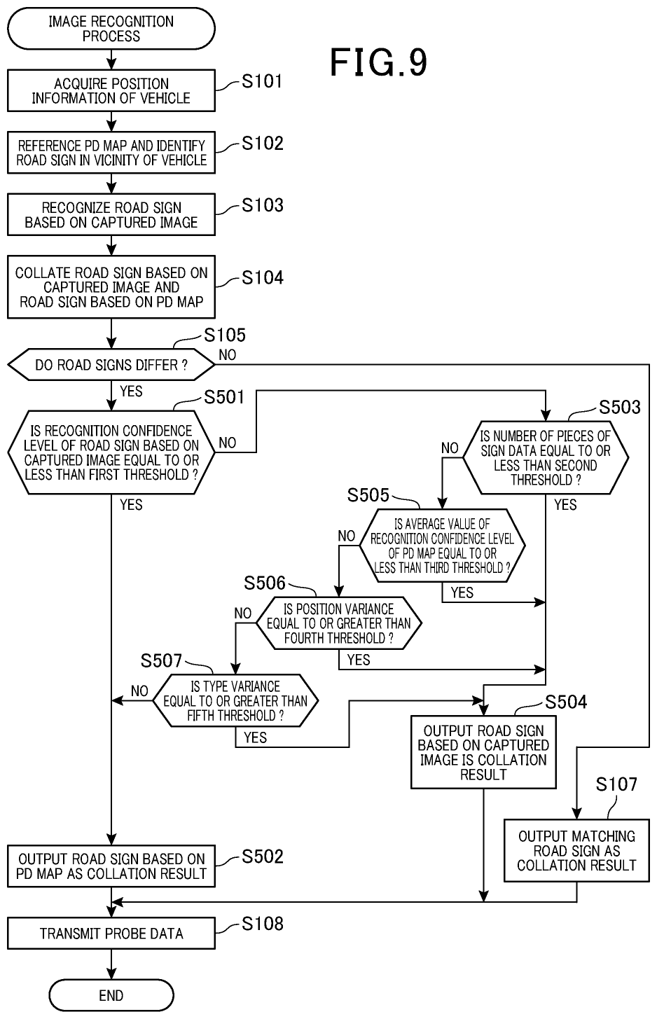

Next, an image recognition process according to the third embodiment will be described with reference to FIG. 9. The image recognition process is performed by the image recognition apparatus 33 of the vehicle 102 at every predetermined cycle.

When the image recognition process is started, in a manner similar to that according to the first embodiment, the image recognition apparatus 33 performs the processes at steps S101 to S105. When the determination result at step S105 is negative, the image recognition apparatus 33 performs steps S107 and S108 and ends the image recognition process.

Meanwhile, when the determination result at step S105 is affirmative, that is, when the type of the road sign that is based on the captured image and the type of the road sign that is based on the PD map differ, the image recognition apparatus 33 determines whether the recognition confidence level of the road sign that is recognized at step S103 is equal to or less than a first threshold (step S501). When the determination result is affirmative, the image recognition apparatus 33 outputs, to the display apparatus 36, the collation result that is the type of the road sign that is identified based on the PD map (step S502).

Meanwhile, when the determination result at step S501 is negative, the image recognition apparatus 33 identifies the number of pieces of probe data that serve as the basis of generation of the road sign to be collated based on the PD map, and determines whether the number of pieces of probe data is equal to or less than a second threshold (step S503). That is, the image recognition apparatus 33 acquires the number of pieces of data that are associated with the road sign in the PD map, and determines whether the number of pieces of data is equal to or less than the second threshold. When the determination result is affirmative, the image recognition apparatus 33 outputs, to the display apparatus 36, the collation result that is the type of the road sign that is recognized based on the captured image at step S103 (step S504).

In addition, when the determination result at step S503 is negative, the image recognition apparatus 33 identifies the average value of the recognition confidence levels of the road sign to be collated based on the PD map, and determines whether the average value is equal to or less than a third threshold (step S505). That is, the image recognition apparatus 33 acquires the average value of the recognition confidence levels that are associated with the road sign in the PD map and determines whether the average value is equal to or less than the third threshold value. When the determination result is affirmative, the image recognition apparatus 33 proceeds to step S504 and outputs, to the display apparatus 36, the collation result that is type of the road sign that is recognized based on the captured image at step S103.

Meanwhile, when the determination result at step S505 is negative, the image recognition apparatus 33 identifies the position variance of the road sign to be collated based on the PD map, and determines whether the position variance is equal or greater than a fourth threshold (step S506). That is, the image recognition apparatus 33 acquires the position variance that is associated with the road sign in the PD map and determines whether the position variance is equal to or greater than the fourth threshold. When the determination result is affirmative, the image recognition apparatus 33 proceeds to step S504 and outputs, to the display apparatus 36, the collation result that is the type of the road sign that is recognized based on the captured image at step S103.

Meanwhile, when the determination result at step S506 is negative, the image recognition apparatus 33 identifies the type variance of the road sign to be collated based on the PD map, and determines whether the type variance is equal or greater than a fifth threshold (step S507). That is, the image recognition apparatus 33 acquires the type variance that is associated with the road sign in the PD map, and determines whether the type variance is equal to or greater than the fifth threshold. When the determination result is affirmative, the image recognition apparatus 33 proceeds to step S504 and outputs, to the display apparatus 36, the collation result that is the type of the road sign that is recognized based on the captured image at step S103.

In addition, when the determination result at step S507 is negative, the image recognition apparatus 33 proceeds to step S502 and outputs, to the display apparatus 36, the collation result that is the type of the road sign that is identified based on the PD map.

When the process at step S502 or S504 is ended, the image recognition apparatus 33 generates the probe data that includes the sign data of the road sign that is recognized based on the captured image, and transmits the probe data to the cloud server 101 through the onboard communication apparatus 35 (step S108). Then, the image recognition process is ended.

According to the third embodiment, effects such as those below can be achieved.

When the road signs do not match, when the recognition confidence level of the road sign that is recognized at step S103 based on the captured image is equal to or less than the first threshold, the image recognition apparatus 33 that serves as the collating unit 46 does not select (determine) the road sign that is recognized based on the captured image as the collation result. As a result, information that has a higher reliability level can be selected and displayed as the collation result.

In addition, when the road signs do not match, the image recognition apparatus 33 that serves as the collating unit 46 identifies the number of pieces of sign data that serve as the basis for generation of the road sign to be collated based on the PD map. When the number of pieces of sign data is equal to or less than the second threshold, the image recognition apparatus 33 does not select (determine) the road sign that is based on the PD map as the collation result. That is, when the number of pieces of probe data that serves as the basis for generation is small, the likelihood of erroneous recognition being high can be taken into consideration. Information that has a higher reliability level can be selected and displayed as the collation result.

Furthermore, when the road signs do not match, the image recognition apparatus 33 that serves as the collating unit 46 identifies the average value of the recognition confidence levels of the road sign to be collated based on the PD map. When the average value is equal to or less than the third threshold, the image recognition apparatus 33 does not select (determine) the road sign that is based on the PD map as the collation result. That is, when the average value of the recognition confidence levels in the pieces of sign data that serve as the basis for generation is small, the likelihood of erroneous recognition being high can be taken into consideration. Information that has a higher reliability level can be selected and displayed as the collation result.

In addition, when the road signs do not match, the image recognition apparatus 33 that serves as the collating unit 46 identifies the position variance of the road sign to be collated based on the PD map. When the position variance is equal to or greater than the fourth threshold, the image recognition apparatus 33 does not select (determine) the road sign that is based on the PD map as the collation result. That is, when the variation in the pieces of position information of the pieces of sign data that serve as the basis for generation is great, the likelihood of erroneous recognition being high can be taken into consideration. Information that has a higher reliability level can be selected and displayed as the collation result.

Furthermore, when the road signs do not match, the image recognition apparatus 33 that serves as the collating unit 46 identifies the type variance of the road sign to be collated based on the PD map. When the type variance is equal to or greater than the fifth threshold, the image recognition apparatus 33 does not select (determine) the road sign that is based on the PD map as the collation result. That is, when the variation in the types of the pieces of sign data that serve as the basis for generation is great, the likelihood of erroneous recognition being high can be taken into consideration. Information that has a higher reliability level can be selected and displayed as the collation result.

### Fourth Embodiment

A portion of the driving assistance system according to the above-described first embodiment may be modified in a following manner. Here, according to a fourth embodiment below, descriptions of sections that are identical or equivalent to those according to the first embodiment are omitted.

According to the fourth embodiment, a storage process and a map generation process that are performed by the cloud server 101 are similar to those according to the third embodiment. Therefore, descriptions of these processes according to the fourth embodiment are omitted. Descriptions according the third embodiment are applicable.

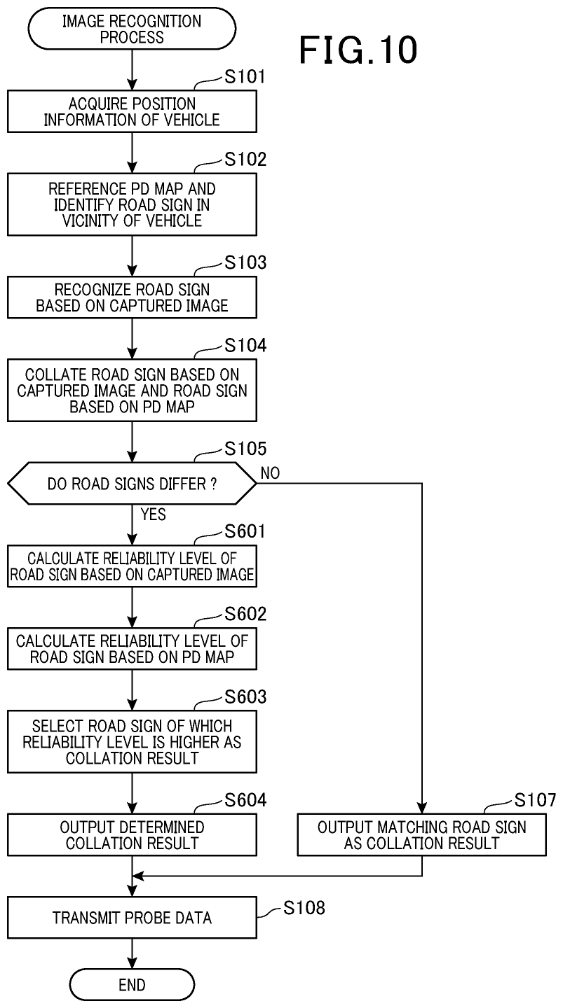

Next, an image recognition process according to the fourth embodiment will be described with reference to FIG. 10. The image recognition process is performed by the image recognition apparatus 33 of the vehicle 102 at every predetermined cycle.

When the image recognition process is started, in a manner similar to that according to the first embodiment, the image recognition apparatus 33 performs the processes at steps S101 to S105. When the determination result at step S105 is negative, the image recognition apparatus 33 performs steps S107 and S108 and ends the image recognition process.

Meanwhile, when the determination result at step S105 is affirmative, that is, when the type of the road sign that is based on the captured image and the type of the road sign that is based on the PD map differ, the image recognition apparatus 33 calculates a reliability level of the road sign that is based on the captured image based on the recognition confidence level of the road sign that is recognized at step S103 (step S601). At step S601, the recognition confidence level of the road sign may be directly used as the reliability level of the road sign that is based on the captured image. Alternatively, the recognition confidence level may be adjusted by taking into consideration a road state (such as weather and period of time, such as nighttime) and used as the reliability level.

Next, the image recognition apparatus 33 calculates a reliability level of the road sign that is based on the PD map using various pieces of information that are included in the PD map (step S602). Specifically, the image recognition apparatus 33 references the PD map and acquires the average value of the recognition confidence levels that are associated with the road sign to be collated. The image recognition apparatus 33 then sets the average value as a base value of the reliability level of the road sign that is based on the PD map. Therefore, the reliability level is higher when the average value of the recognition confidence levels is high, compared to when the recognition confidence level is low.

Next, the image recognition apparatus 33 references the PD map and identifies the number of pieces of sign data (probe data) that serve as the basis for generation of the road sign that is associated with the road sign that is collated. The image recognition apparatus 33 adjusts the reliability level based on the number of pieces of sign data. Specifically, the base value is adjusted such that the reliability level is higher when the number of pieces of sign data is large, compared to when the number of pieces of sign data is small.

Furthermore, the image recognition apparatus 33 references the PD map and acquires the position variance that is associated with the road sign to be collated. The image recognition apparatus 33 adjusts the reliability level based on the position variance. Specifically, the base value (the base value that is already adjusted based on the number of pieces of sign data) is adjusted such that the reliability level is lower when the position variance is large, compared to when the position variance is small.

In a similar manner, the image recognition apparatus 33 references the PD map and acquires the type variance that is associated with the road sign to be collated. The image recognition apparatus 33 adjusts the reliability level based on the type variance. Specifically, the base value (the base value that is already adjusted based on the number of pieces of sign data and the position variance) is adjusted such that the reliability level is lower when the type variance is large, compared to when the type variance is small.

When the reliability levels are calculated at steps S601 and S602, the image recognition apparatus 33 compares the reliability level of the road sign that is based on the captured image and the reliability level of the road sign that is based on the PD map, and selects (determines) the road sign that has the higher reliability level as the collation result (step S603).

Then, the image recognition apparatus 33 outputs, to the display unit 36, the collation result that is the type of the road sign that is determined at step S603 (step S604). When the process at step S604 is ended, the image recognition apparatus 33 generates the probe data that includes the sign data of the road sign that is recognized based on the captured image, and transmits the probe data to the cloud server 101 through the onboard communication apparatus 35 (step S108). Then, the image recognition process is ended.

According to the fourth embodiment, effects such as those below can be achieved.

When the road signs do not match, the image recognition apparatus 33 that serves as the collating unit 46 calculates the reliability level of the road sign that is based on the captured image and the reliability level of the road sign that is based on the PD map, and selects (determines) the collation result by comparing the reliability levels. Therefore, information that has a higher reliability level can be selected and displayed as the collation result.

The reliability level of the road sign that is based on the captured image is calculated based on the recognition confidence level of the road sign. In addition, the reliability level of the road sign that is based on the PD map is adjusted based on the number of pieces of sign data (probe data) that serve as the basis for generation, the average value of the recognition confidence levels, the position variance, and the type variance that are associated with the road sign. As a result, information that has a higher reliability level can be selected and displayed as the collation result.

Here, according to the fourth embodiment, the reliability level of the road sign that is based on the PD map is calculated based on the number of pieces of sign data, the average value of the recognition confidence levels, the position variance, and the type variance. However, the reliability level may be calculated based on any one value, or two or more values, among the number of pieces of sign data, the average value of the recognition confidence levels, the position variance, and the type variance

### Other Embodiments

A portion of the configurations according to the above-described embodiments may be modified. Hereafter, other embodiments (modifications) in which a portion of the configurations according to the above-described embodiments is modified will be described.

According to the above-described second embodiment, the image recognition apparatus 33 may include the determination result of the scene determination (the determination result as to whether a construction zone is present) by the image recognition apparatus 33 in the probe data. Then, the cloud server 101 may use the determination result of the scene determination as a basis for determination as to whether the PD map is updated.

For example, when the change point of the likelihood is identified based on the sign data of which the position information corresponds to the construction zone, the cloud server 101 may decrease the determination values (the first determination value and the second determination value). That is, a determination criterion for the change point may be decreased, taking into consideration temporary road signs being frequently set in a construction zone. That is, even a small amount of change may be considered to be a change point. As a result, the PD map can be promptly updated in correspondence to temporary road signs that are set in a construction zone.

Here, in the case of this modification, the probe data may include information that is related to an object that indicates that construction is being performed. The server 101 may perform the scene determination in which determination for identifying a construction zone is performed based on the probe data.

When the determination result at step S302 according to the above-described second embodiment is negative, that is, when a construction zone is not recognized, the image recognition apparatus 33 may determine that the determination is not possible, regardless of the recognition confidence level. In addition, when the recognition confidence level of the road sign is less than a predetermined value, the road sign that is based on the PD map may be the collation result. Furthermore, the processes at steps S501 to S507 according to the third embodiment and the processes at steps S601 to S604 according to the fourth embodiment may be performed.

According to the above-described third embodiment, an order in which the processes at steps S501 and S503 to S507 are performed may be arbitrarily changed. For example, the determination at steps S503 to S507 may be performed before step S501. Step S501 may be performed when the determination result at step S507 is negative.

According to the above-described third embodiment, the first to fifth thresholds may be respectively set to arbitrary values.

According to the above-described third embodiment, when the determination result at step S501 is negative, determination that the determination is not possible may be made. At this time, a result may not be displayed.

According to the above-described embodiments, the vehicle 102 is both the measurement vehicle that transmits the measured probe data to the cloud server 101, and the user vehicle that is provided the PD map from the cloud server 101 and uses the PD map. However, the vehicle 102 may serve as only either of the measurement vehicle and the user vehicle.

The control unit and the method thereof described in the present disclosure may be implemented by a dedicated computer that is provided so as to be configured by a processor and a memory, the processor being programmed to provide one or a plurality of functions that are realized by a computer program. Alternatively, the control unit and the method thereof described in the present disclosure may be implemented by a dedicated computer that is provided by a processor being configured by a single dedicated hardware logic circuit or more.

Still alternatively, the control unit and the method thereof described in the present disclosure may be implemented by a single dedicated computer or more, the dedicated computer being configured by a combination of a processor that is programmed to provide one or a plurality of functions, a memory, and a processor that is configured by a single hardware logic circuit or more. In addition, the computer program may be stored in a non-transitory computer-readable storage medium that can be read by a computer as instructions performed by the computer.

What is claimed is:

1. A driving assistance system that includes a driving assistance apparatus that updates map information based on travel trajectory information that is acquired from a measurement vehicle and provides the map information to a user vehicle that uses the map information, the driving assistance system comprising:
a data storage unit that stores therein, in time series, pieces of sign data that are related to a road sign and included in the travel trajectory information; and
a map updating unit that updates the map information based on the pieces of sign data that are stored in the data storage unit, wherein
the map updating unit references the pieces of sign data that are stored in the data storage unit, identifies a change point in the pieces of sign data that are stored in time series, and updates the map information based on the change point.

2. The driving assistance system according to claim 1, wherein:
the sign data includes at least position information and type of the road sign; and
in pieces of sign data of which the pieces of position information correspond to one another, the map updating unit calculates changes over time in likelihood that is based on a number of pieces of stored sign data, for each type, and identifies the change point in the pieces of sign data based on at least one of increase and decrease in likelihood.

3. The driving assistance system according to claim 2, wherein:
the pieces of sign data respectively include a recognition confidence level related to recognition of the road sign; and
the map updating unit calculates the changes over time in likelihood for each type, upon weighting the pieces of sign data based on the recognition confidence levels.

4. The driving assistance system according to claim 2, wherein:
the map updating unit calculates the likelihood upon performing normalization based on a number of pieces of travel trajectory information that serve as a basis for generation of the map information.

5. The driving assistance system according to claim 1, wherein:
scene determination in which determination for identifying a construction zone is performed is performed based on the travel trajectory information that is acquired from the measurement vehicle and a determination result thereof is acquired, or a determination result of the scene determination is acquired from the measurement vehicle; and
when the change point in the sign data of which the position information corresponds to the construction zone is identified, the map updating unit identifies even a small amount of change as the change point, compared to when the position information does not correspond to the construction zone.

6. The driving assistance system according to claim 1, wherein:
the user vehicle includes
an image information acquiring unit that acquires image information in which a traveling road on which the own vehicle is traveling is captured;
a sign recognizing unit that recognizes a road sign based on the image information;
a receiving unit that receives the map information that is provided from the driving assistance apparatus;
a sign identifying unit that references the map information that is received by the receiving unit and identifies a road sign;
a collating unit that collates the road sign that is recognized by the sign recognizing unit and the road sign that is based on the map information, and selects either of the road signs as a collation result or selects neither; and
an outputting unit that outputs the collation result.

7. The driving assistance system according to claim 6, wherein:
when the road sign that is recognized by the sign recognizing unit and the road sign that is based on the map information match, the collating unit sets the matching road sign as the collation result; and
when the road signs do not match, the collating unit sets the road sign that is recognized by the sign recognizing unit as the collation result.

8. The driving assistance system according to claim 6, wherein:
the user vehicle includes a scene determining unit that performs scene determination in which a construction zone is identified based on the image information, and
when the road sign that is recognized by the sign recognizing unit and the road sign that is based on the map information do not match, and the scene determining unit determines that the road sign is provided in a construction zone, the collating unit sets the road sign that is recognized by the sign recognizing unit as the collation result.

9. The driving assistance system according to claim 6, wherein:
the user vehicle is also the measurement vehicle, and includes a transmitting unit that includes the sign data of the road sign that is recognized by the sign recognizing unit in the travel trajectory information and transmits the travel trajectory information to the driving assistance apparatus.

10. A driving assistance apparatus that updates map information based on travel trajectory information that is acquired from a measurement vehicle and provides the map information to a user vehicle that uses the map information, the driving assistance apparatus comprising:
a data storage unit that stores therein, in time series, pieces of sign data that are related to a road sign and included in the travel trajectory information; and
a map updating unit that updates the map information based on the pieces of sign data that are stored in the data storage unit, wherein
the map updating unit references the pieces of sign data that are stored in the data storage unit, identifies a change point in the pieces of sign data that are stored in time series, and updates the map information based on the change point.

11. A driving assistance method that is performed by a driving assistance apparatus that updates map information based on travel trajectory information that is acquired from a measurement vehicle and provides the map information to a user vehicle that uses the map information, the driving assistance method comprising:
a data storage step of storing, in time series, pieces of sign data that are related to a road sign and included in the travel trajectory information; and
a map updating step of updating the map information based on the pieces of sign data that are stored at the data storage step, wherein
at the map updating step, the pieces of sign data that are stored at the data storage step are referenced, a change point in the pieces of sign data that are stored in time series is identified, and the map information is updated based on the change point.

12. An image recognition apparatus comprising:
an image information acquiring unit that acquires image information in which a traveling road on which an own vehicle is traveling is captured;
a sign recognizing unit that recognizes a road sign based on the image information;
a sign identifying unit that references map information that is generated based on travel trajectory information of a vehicle and identifies a road sign in the vicinity of the own vehicle;
a collating unit that collates the road sign that is recognized by the sign recognizing unit and the road sign that is based on the map information, and when the road signs match, sets the matching road sign as a collation result, and when the road signs do not match, selects either of the road signs or selects neither; and
an outputting unit that outputs the collation result.

13. The image recognition apparatus according to claim 12, wherein:
when the road signs do not match, the collating unit calculates a reliability level of the road sign that is based on the image information and calculates a reliability level of the road sign that is based on the map information, compares the reliability levels, and selects the road sign that has a higher reliability level as the collation result.

14. The image recognition apparatus according to claim 13, wherein:
the map information is generated based on a plurality of pieces of travel trajectory information;
for each road sign, a number of pieces of travel trajectory information that serve as a basis for generation of the road sign is associated with the map information; and
the collating unit calculates the reliability level of the road sign that is based on the map information to be higher when the number of pieces of travel trajectory information that serve as the basis for generation of the road sign to be collated is large, compared to when the number of pieces of travel trajectory information that serve as the basis for generation is small.

15. The image recognition apparatus according to claim 13, wherein:
the map information is generated based on a plurality of pieces of travel trajectory information;
for each road sign, an average value of reliability confidence levels that are set when the road sign is recognized by vehicles is associated with the map information; and
the collating unit calculates the reliability level of the road sign that is based on the map information to be higher when the average value of the recognition confidence levels of the road sign to be collated is high, compared to when the average value of the recognition confidence levels is low.

16. The image recognition apparatus according to claim 13, wherein:
the map information is generated based on a plurality of pieces of travel trajectory information;
for each road sign, a position variance that indicates a magnitude of scatter in the pieces of position information that indicate positions in which the road signs that are included in the pieces of travel trajectory information that serve as the basis for generation of the road sign are detected is associated with the map information; and
the collating unit calculates the reliability level of the road sign that is based on the map information to be lower when the position variance of the road sign to be collated is large, compared to when the position variance is small.

17. The image recognition apparatus according to claim 13, wherein:
the map information is generated based on a plurality of pieces of travel trajectory information;
for each road sign, a type variance that indicates a magnitude of scatter in the types of the road signs that correspond to the pieces of position information of the road sign that are included in the pieces of travel trajectory information that serve as the basis for generation of the road sign is associated with the map information; and
the collating unit calculates the reliability level of the road sign that is based on the map information to be lower when the type variance of the road sign to be collated is large, compared to when the type variance is small.

18. The image recognition apparatus according to claim 12, wherein:
when the road signs do not match, when the recognition confidence level of the road sign that is recognized by the sign recognizing unit is equal to or less than a first threshold based on the image information, the collating unit does not select the road sign that is recognized by the sign recognizing unit as the collation result.

19. The image recognition apparatus according to claim 12, wherein:
the map information is generated based on a plurality of pieces of travel trajectory information;
for each road sign, a number of pieces of travel trajectory information that serve as the basis for generation of the road sign is associated with the map information; and
when the road signs do not match, the collating unit identifies the number of pieces of travel trajectory information that serve as the basis for generation of the road sign to be collated based on the map information, and does not select the road sign that is based on the map information as the collation result when the number of pieces of travel trajectory information is equal to or less than a second threshold.

20. The image recognition apparatus according to claim 12, wherein:
the map information is generated based on a plurality of pieces of travel trajectory information;
for each road sign, an average value of the recognition confidence levels that are set when the road sign is recognized by vehicles is associated with the map information; and
when the road signs do not match, the collating unit identifies the average value of the recognition confidence levels of the road sign to be collated based on the map information, and does not select the road sign that is based on the map information as the collation result when the average value is equal to or less than a third threshold.

21. The image recognition apparatus according to claim 12, wherein:
the map information is generated based on a plurality of pieces of travel trajectory information;
for each road sign, a position variance that indicates a magnitude of scatter in the pieces of position information that indicate positions in which the road signs that are included in the pieces of travel trajectory information that serve as the basis for generation of the road sign are detected is associated with the map information; and
when the road signs do not match, the collating unit identifies the position variance of the road sign to be collated based on the map information, and does not select the road sign that is based on the map information as the collation result when the position variance is equal to or greater than a fourth threshold.

22. The image recognition apparatus according to claim 12, wherein:
the map information is generated based on a plurality of pieces of travel trajectory information;
for each road sign, a type variance that indicates a magnitude of scatter in the types of the road signs that correspond to the pieces of position information of the road sign that are included in the pieces of travel trajectory information that serve as the basis for generation of the road sign is associated with the map information; and
when the road signs do not match, the collating unit identifies the type variance of the road sign to be collated based on the map information, and does not select the road sign that is based on the map information as the collation result when the type variance is equal to or greater than a fifth threshold.

23. An image recognition method that is performed by an image recognition apparatus, the image recognition method comprising:
an image information acquiring step of acquiring image information in which a traveling road on which an own vehicle is traveling is captured;
a sign recognizing step of recognizing a road sign based on the image information;
a sign identifying step of referencing map information that is generated based on travel trajectory information of a vehicle and identifying a road sign in the vicinity of the own vehicle;
a collating step of collating the road sign that is recognized at the sign recognizing step and the road sign that is based on the map information, and when the road signs match, setting the matching road sign as a collation result, and when the road signs do not match, selecting either of the road signs or selecting neither; and
an outputting step of outputting the collation result.
